(19) United States
(12) Patent Application Publication
(10) Pub. No.: US 2020/0189042 A1
(43) Pub. Date: Jun. 18, 2020

(54) LASER BEAM PROCESSING METHOD, PROCESSED OBJECT, AND PROCESSING MATERIAL

(71) Applicant: ROLAND DG CORPORATION, Hamamatsu-shi, Shizuoka (JP)

(72) Inventor: Jun UEDA, Hamamatsu-shi (JP)

(21) Appl. No.: 16/629,048

(22) PCT Filed: Jun. 6, 2018
(86) PCT No.: PCT/JP2018/021715

§ 371 Date: Jan. 7, 2020

(30) Foreign Application Priority Data
Aug. 23, 2017 (JP) 2017-160101

(51) Int. Cl. B23K 26/70; B23K 26/53; B23K 26/03

(52) U.S. Cl. CPC B23K 26/70; B23K 26/0006; B23K 26/032; B23K 26/53

(57) ABSTRACT

A laser beam processing method includes impinging a laser beam onto a predetermined location inside a light-transmissive material and forming a code in which predetermined information is recorded.

### BACKGROUND OF THE INVENTION

### 1. Field of the Invention

The present invention relates to a laser beam processing method, a processed object, and a processing material.

### 2. Description of the Related Art

Techniques for processing the surface of a material using a laser beam are known. For instance, “Laser Marking Processing”, [online], Yamato Denki Co., Ltd., [retrieved on Jul. 5, 2017], Internet <URL: http://www.yamato-elec.co.jp/tech/> discloses an example of using laser beam processing to form a barcode, a data matrix, or the like (“code” hereinafter), on the surface of a material.

Codes formed on the surface of a material may, however, become unrecognizable due to degradation over time or be falsified by a third party.

### SUMMARY OF THE INVENTION

Preferred embodiments of the present invention provide laser beam processing methods to form a code that is less prone to degrade over time or to falsification, and processed objects and processing materials in which a code is formed using the methods.

According to a preferred embodiment of the present invention, a laser beam processing method includes impinging a laser beam onto a predetermined location inside a light-transmissive material and forming a code in which predetermined information is recorded.

Other features of other preferred embodiments of the present invention will be revealed through the following disclosure and description.

According to preferred embodiments of the present invention, a code that is less prone to degrade over time or to falsification is able to be formed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram illustrating a configuration of a processing system according to a first preferred embodiment of the present invention.

FIG. 2 is a diagram schematically illustrating a processed object according to the first preferred embodiment of the present invention.

FIG. 3 is a diagram schematically illustrating the processed object according to the first preferred embodiment of the present invention.

FIG. 4 is a flowchart illustrating a laser beam processing method according to the first preferred embodiment of the present invention.

### DETAILED DESCRIPTION OF THE PREFERRED EMBODIMENTS

### First Preferred Embodiment

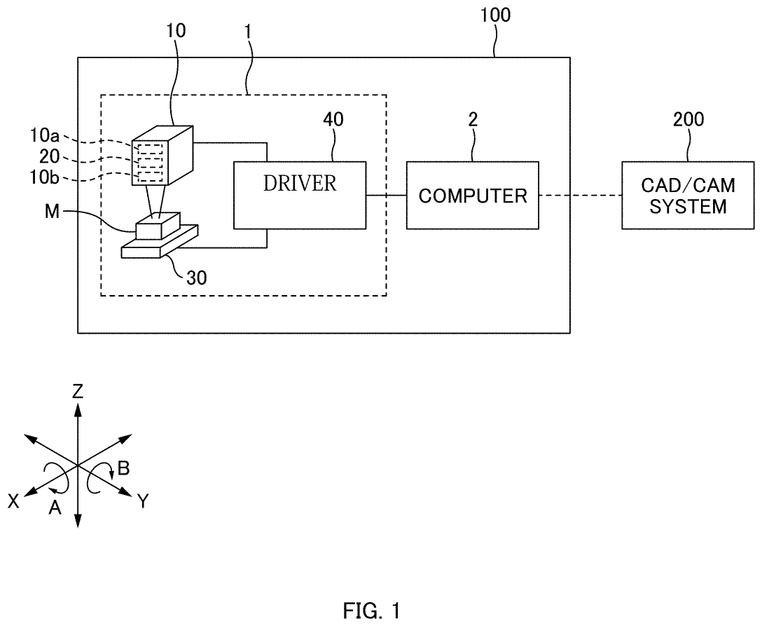

Laser beam processing methods according to preferred embodiments of the present invention will be described with reference to FIGS. 1 through 4. A laser beam processing method according to a preferred embodiment of the present invention involves impinging a laser beam onto a predetermined location inside a light-transmissive material and forming a code in which predetermined information is recorded. Such a laser beam processing method can be performed by a processing system 100. FIG. 1 is a diagram illustrating the processing system 100 and a computer-aided design/computer-aided manufacturing (CAD/CAM) system 200.

The processing system 100 processes a processing material M using a laser beam to form a processed object or a code. Use of a laser beam makes it possible to perform contactless processing on the processing material M. The processing system 100 includes a processing apparatus 1 and a computer 2. Note that the processing system 100 may be defined by the processing apparatus 1 alone given that functions of the computer 2 are implemented by the processing apparatus 1.

A material that transmits laser beams (light-transmissive material) is used for the processing material M, specific examples thereof including a glass material or a highly light-transmissive resin material (e.g. acrylic resin). It is not required that the transmittance of the processing material M be 100% (transparent), and it is sufficient if the transmittance is a value such that a laser beam can reach a processed region (to be described later) or a predetermined location (to be described later) inside the material and a code (to be described later) formed inside the material can be read.

The processed object is obtained as a result of a laser beam being impinged onto the processed region in the processing material M. The processing system 100 processes the processing material M in accordance with processing data (to be described later) created in advance. The processed region is a predetermined region on the surface or inside of the material onto which a laser beam is impinged during formation of the processed object.

The description of this preferred embodiment illustrates a microfluidic device as an example of the processed object. Microfluidic devices are widely used in the field of biochemistry and chemical engineering. A microfluidic device includes a port to supply a fluid (blood, reagent, etc.) into the device, a port to discharge the fluid outside the device, and a flow path to connect the ports together.

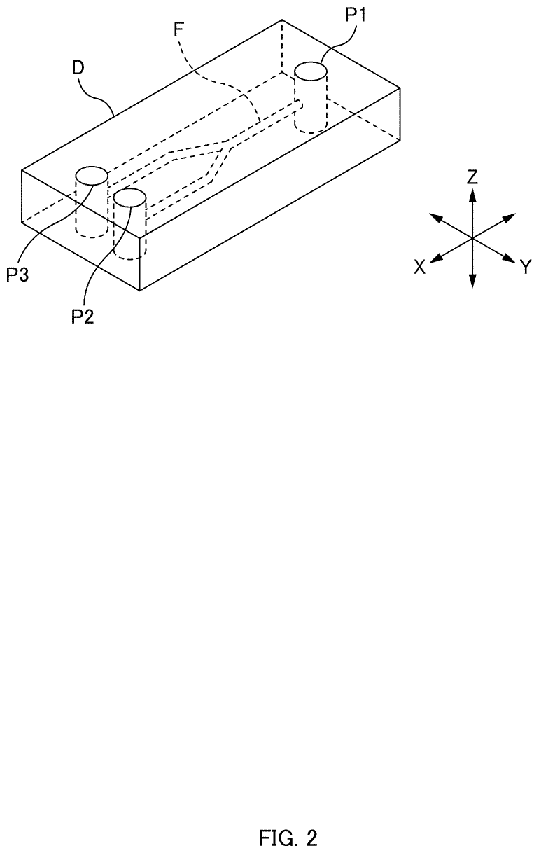

FIG. 2 is a perspective view of a microfluidic device D including three ports P1 through P3 and a bifurcated flow path portion F. In FIG. 2, the lengthwise direction (depth direction) of the microfluidic device D corresponds to the X direction, the transverse direction (widthwise direction) thereof corresponds to the Y direction, and the height direction thereof corresponds to the Z direction.

Although there are no limitations on a laser beam to be used for the processing, it is preferable to use an ultrashort-pulsed laser beam when processing the inside of the material. An ultrashort-pulsed laser beam is a laser beam, the width of a single pulse of which is several picoseconds to several femtoseconds. Quick impingement of an ultrashort-pulsed laser beam onto the inside of the material makes it possible to carry out abrasion processing (non-thermal processing). Abrasion processing is a method for melting a material by laser beam impingement. A material that has been melted momentarily evaporates, scatters, and is removed, so a cavity forms at the location onto which the laser beam has impinged. Compared to typical heat processing, abrasion processing causes less heat-related damage to the portion being processed and enables selective processing of exclusively the location onto which the laser beam impinges.

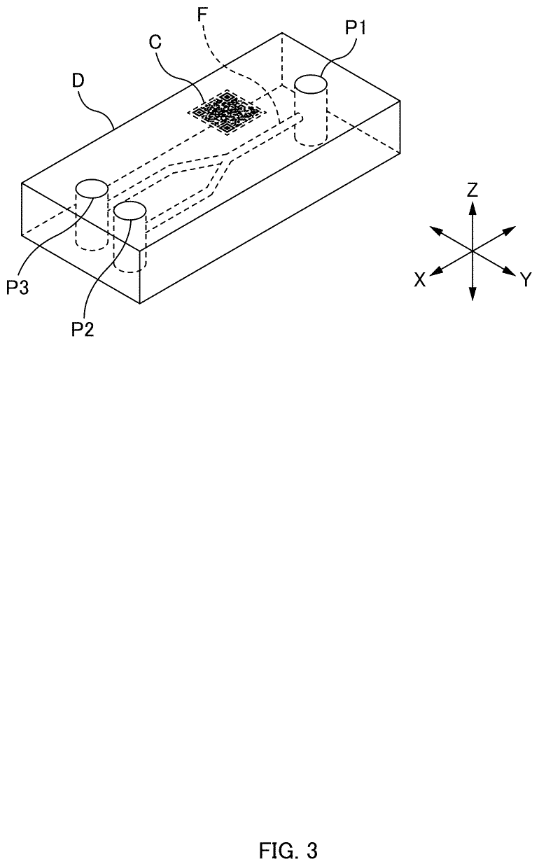

The code is an identifier in which predetermined information is recorded. The code may be a barcode, a two-dimensional code (e.g., quick response (QR) code (registered trademark)), a data matrix, a three-dimensional code, or the like. The predetermined information may be, for example, processing information relating to the processed object, and may specifically be conditions for using the processed object, precautions for handling the processed object, or the like. The processing system 100 forms the code at the predetermined location inside the processing material M by impinging a laser beam in accordance with code processing data (to be described later) created in advance. The predetermined location is a predetermined region inside the material onto which a laser beam is impinged when processing the code. FIG. 3 illustrates an example in which a two-dimensional code C has been formed in the microfluidic device D in FIG. 2.

A user can refer to the information recorded in the code formed in the processed object by reading the code using a known method. To cite an example where the code is a QR code, the user can confirm the information recorded in the code on the user's portable terminal by using QR code reading application software that has been installed in the portable terminal. To cite another example where the code is a minute one, it is possible to use a microscope, or the like, to acquire an image in which the code is enlarged and read the image using a portable terminal.

The processing apparatus 1 in this preferred embodiment has five drive axes (X axis, Y axis, Z axis, A rotation axis (rotation axis about X axis), and B rotation axis (rotation axis about Y axis)). The processing apparatus 1 performs abrasion processing on the (inside of the) processing material M by impinging a laser beam onto the processing material M in accordance with the processing data and the code processing data. As illustrated in FIG. 1, the processing apparatus 1 includes an impinger 10, an adjuster 20, a retainer 30, and a driver 40.

The impinger 10 impinges a laser beam onto the processing material M. The impinger 10 includes, for example, a laser oscillator 10a and a lens group 10b to allow a laser beam from the oscillator 10a to converge onto the processing material M. The laser oscillator 10a may be provided on the outside of the processing apparatus 1.

The adjuster 20 adjusts the impingement pattern of a laser beam. The adjuster 20 includes at least one of a galvanometer mirror, a Fresnel lens, a diffractive optical element (DOE), a beam shaper to perform fragmentation processing, a liquid crystal on silicon-spatial light modulator (LCOS-SLM), etc. The adjuster 20 is disposed, for example, between the oscillator 10a and the lens group 10b inside the impinger 10. An impingement pattern that can be used in a processing apparatus is determined in accordance with the configuration of the adjuster 20 provided in the apparatus.

The retainer 30 retains the processing material M. A method for retaining the processing material M is not limited to a certain way as long as the retained processing material M can be moved and/or rotated along the five axes.

The driver 40 moves the impinger 10 (adjuster 20) and the retainer 30 relative to each other. The driver 40 includes, for example, a servomotor to perform driving.

The computer 2 controls the operations of the various configurations included in the processing apparatus 1. Specifically, the computer 2 controls the impinger 10 and the driver 40 so as to perform the abrasion processing by impinging a laser beam onto the predetermined location inside the material and form the code in accordance with the code processing data. The computer 2 also controls the impinger 10 and the driver 40 so as to perform the abrasion processing by impinging a laser beam onto the processed region on the surface of the material or inside the material and form the processed object in accordance with the processing data. When doing so, the computer 2 performs the laser beam impingement in such a manner that the predetermined location of the code and the processed region do not overlap.

Note that the number of axes for the processing system 100 may be other than five given that processing of the processed object or the code is possible. For example, it is possible to use a processing apparatus including three axes, namely a drive axis to drive the impinger 10 in the Z direction and drive axes to drive the retainer 30 in the X direction and the Y direction. Besides, the adjuster 20 is not an essential configuration. If there is no adjuster 20, a laser beam emitted from the impinger 10 is focused onto a single point and therefore impinges onto the processed region or the predetermined location in the form of a point. If the processed region or the predetermined location is processed in this way by spotting the laser beam onto points (point group), then compared to the case where an adjuster 20 is involved, the processing requires more time but finer processing can be performed, making it possible to form a processed object more accurately or a code that can be read with higher precision.

The CAD/CAM system 200 creates the code processing data and the processing data used by the processing system 100.

The code processing data is used by the processing system 100 when forming the code in which the predetermined information is recorded at the predetermined location inside the material.

Specifically, the code processing data is formed by converting (binarizing) image data representing the code into dots. Each dot is specified by X, Y, Z coordinate values indicating the code formation location (predetermined location) inside the material. The CAD/CAM system 200 creates the code processing data by, for example, referring to shape data for the processing material M and adjusting the location (coordinate values) of each dot inside the processing material M.

The image data which the code processing data is based on can be created using known methods which are used when creating image data for barcodes, QR codes, etc.

When a code formed inside a material is read, the presence of a laser beam-processed region (a region corresponding to the processed region) in the background of the code may be a hindrance to the reading of the code. In this regard, it is preferred that when creating the code processing data, the coordinate values of the code be adjusted so that the predetermined location of the code does not overlap the processed region. Here, it is more preferred that the code and the processed region do not overlap in the direction in which the code is read. For a two-dimensional code such as the code C illustrated in FIG. 3, for example, the code is typically read from the Z direction. For a case like this, the CAD/CAM system 200 adjusts the coordinate values of the code C so that the code C and the processed region (a region corresponding to the flow path portion F and the ports P1 through P3), as seen in the Z direction, do not overlap. In other words, the CAD/CAM system 200 carries out the adjustment so that the X, Y coordinate values of the code C and the X, Y coordinate values of the processed region do not overlap.

In the example in FIG. 3, the code C preferably is formed so as to be parallel or substantially parallel to the X-Y plane of the microfluidic device D, but the code C does not have to be parallel to a specific plane. For example, in the example in FIG. 3, the code C may be formed with a predetermined inclination in the Z direction (an inclination to an extent such that the code C remains readable).

The processing data is used by the processing system 100 when processing the material to obtain the processed object.

The processing data specifically is data for specifying the processed region. The processed region is specified by X, Y, Z coordinate values indicating a location at which a laser beam is to be impinged onto the processing material. The CAD/CAM system 200 creates the processing data by, for example, extracting the processed region on the basis of shape data representing the flow path portion F and the ports P1 through P3 of the microfluidic device D illustrated in FIG. 2.

The code processing data and the processing data may include impingement pattern data. The impingement pattern data may designate a method for impinging a laser beam onto the predetermined location or the processed region. In addition, the code processing data and the processing data may include: information on laser beam output (laser beam impingement duration, intensity, etc.) other than the impingement pattern; information on processing accuracy; or information on finishing treatment after processing.

The aforementioned shape data for the flow path portion F and the ports P1 through P3 (e.g. coordinate values in the X, Y, Z directions, shapes, and diameters of the flow path portion F and the ports P1 through P3) and shape data for the processing material M which the microfluidic device D is based on are prepared in advance in the CAD/CAM system 200. These data may, for example, be created by the CAD/CAM system 200, or may be created by another computer and transferred to the CAD/CAM system 200.

The CAD/CAM system 200 outputs the created code processing data and processing data to the processing system 100. The format of the output data can be any, given that the data is readable by the processing system 100.

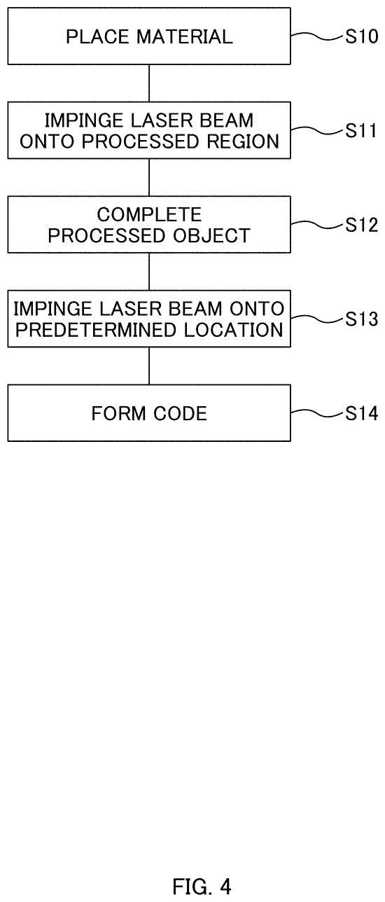

A specific example of the laser beam processing method in this preferred embodiment will now be described with reference to FIG. 4. Here, an example will be described in which, when the microfluidic device D illustrated in FIG. 2 is formed by processing the processing material M, the code is formed inside the device. The code processing data and the processing data for the microfluidic device D are created in advance by the CAD/CAM system 200. The laser beam processing method is executed by the processing system 100. Such a laser beam processing method is installed in advance in the processing system 100 in the form of a dedicated processing program.

First, a processing material M to be used is selected and placed on the retainer 30 of the processing apparatus 1 (S10: place processing material). It is preferred that the shape of the processing material M correspond to the shape data (external shape) used when creating the processing data and the like.

The computer 2 causes the processing apparatus 1 to process the processing material M in accordance with the processing data for the microfluidic device D.

Specifically, the computer 2 controls the processing apparatus 1 in accordance with the processing data such that the processing apparatus 1 impinges a laser beam onto the processed region (S11: impinge laser beam onto processed region).

The computer 2 carries out adjustment such that the position of the laser beam focal point matches the processed region. Specific examples of the adjustment carried out by the computer 2 include: adjustment of the relative positions of the impinger 10 and the driver 40; adjustment of the orientation and/or the angle of the lens group included in the impinger 10; adjustment of the condition of the adjuster 20; and so on. It is preferable to adjust the position of the focal point, etc., while taking the refractive index of the processing material into consideration. After matching the position of the laser beam focal point and the processed region, the computer 2 causes a laser beam to impinge onto the processed region in a predetermined impingement pattern.

As result of impinging a laser beam onto the entire processed region, a microfluidic device D inside which a cavity (the flow path portion F and the ports P1 through P3) is formed is obtained (S12: complete processed object; see FIG. 2).

Next, the computer 2 controls the processing apparatus 1 in accordance with the code processing data such that the processing apparatus 1 forms a code inside the microfluidic device D having been completed in S12. The processing apparatus 1 impinges a laser beam onto the predetermined location indicated by the code processing data (S13: impinge laser beam onto predetermined location). As a result, the code is formed inside the microfluidic device D (S14: form code: see FIG. 3).

If the predetermined location of the code is adjusted in the code processing data so as not to overlap the processed region, the computer 2 controls the processing apparatus 1 such that the code does not overlap the flow path portion F and the ports P1 through P3 in the microfluidic device D having been completed in S12. The processing apparatus 1 impinges a laser beam such that the predetermined location of the code does not overlap the processed region corresponding to the flow path portion F and the ports P1 through P3.

In the example described above, the code C is formed after formation of the microfluidic device D, but it is also possible to form the code C first and then form the microfluidic device D.

As described above, the laser beam processing method in this preferred embodiment makes it possible to impinge a laser beam onto a predetermined location inside a light-transmissive processing material M and form a code in which predetermined information is recorded. The code formed inside the processing material M is less prone to being affected by the condition under which the processed object is kept or stored, and is also less prone to being touched by a third party. In other words, according to the laser beam processing method in this preferred embodiment, the code formed in the processing material can be made less prone to degrade over time or to falsification.

Further, by recording processed object information pertaining to the processed object as the predetermined information in the code, various information pertaining to the processed object can be managed together with the processed object. The operator can easily ascertain the conditions of use, handling precautions, etc. for the processed object by merely reading such a code.

Moreover, the laser beam processing method in this preferred embodiment makes it possible to impinge a laser beam in the step of forming a code such that the predetermined location of the code does not overlap the processed region. Preventing in this way an overlap between the processed region and the location at which the code is formed obviates the problem that it is impossible to read the code because of the presence of the region having been processed by a laser beam.

The microfluidic device D (processed object) in this preferred embodiment is obtained by processing a light-transmissive processing material M, and a code C in which predetermined information is recorded is formed at a predetermined location inside the processing material M. The code C formed inside the microfluidic device D in this way is less prone to degrade over time or to falsification.

This preferred embodiment has described an example in which a code is formed in a processed object formed by the processing system 100, but this example is not limiting. For example, the processing system 100 may be used to form a barcode, in which predetermined information is recorded, in a processed object (e.g. microfluidic device) that is formed from a commercially-available light-transmissive material. Further, the processed object may not be obtained by laser beam processing. For example, ordinary cutting processing may be used to obtain a processed object, and a code may be formed on this processed object using the laser beam processing method in this preferred embodiment.

When, for example, a microfluidic device such as the microfluidic device D illustrated in FIG. 2 is used in actual medical sites or laboratories, it is necessary to record information on the date and time of use, whether the device is used or unused, examination results, etc. For this purpose, there may be used a method in which such information is managed separately using a computer, or the like, or a method in which the information is written directly onto a surface of the microfluidic device D, for example. With the method using a computer for management, however, the correspondence between the information and the microfluidic device D needs to be managed using a separate ID, or the like, which is cumbersome. The method in which the information is written directly on the microfluidic device D is associated with problems relating to a space for writing the information, and the written information may degrade or be falsified.

In view of the above, the laser beam processing method in the aforementioned preferred embodiment may be used to form, inside the processed object, a code in which information on use obtained during use of the processed object is recorded. The information on use may, for example, represent the date and time of use, use condition (used/unused, etc.), examination results, measurement results, etc., or may be information for identifying a subject or a patient. The information on use is an example of “predetermined information”.

It is preferred that the code in which the information on use is recorded be formed inside the processed object in a portion that does not overlap the processed region. Moreover, it is also possible to, for example, form the code in which the information on use is recorded additionally in a processed object in which a code has already been formed, such as the microfluidic device D illustrated in FIG. 3. In this case, the CAD/CAM system 200 creates code processing data that is adjusted so that the code in which the information on use is recorded is formed at a location that does not overlap the code having been formed previously.

When, in this way, information on use, which is obtained during use of a processed object obtained as a result of a laser beam being impinged onto a processed region in a light-transmissive processing material M, is recorded in a code as predetermined information, various information on the use of the processed object can be managed together with the processed object. The operator can easily ascertain the status of use, etc., of the processed object by merely reading such a code (so-called “traceability” is improved).

### Second Preferred Embodiment

Next, a laser beam processing method in a second preferred embodiment of the present invention will be described. The first preferred embodiment described an example in which a code is formed in a processed object. Meanwhile, it is also possible to form a code in a processing material before being processed and form a processed object by reading the code. Hereinbelow, a specific example of this preferred embodiment will be described. Configurations that are substantially the same as those in the first preferred embodiment will not be described in detail again.

The laser beam processing method in this preferred embodiment includes a step of impinging a laser beam onto a predetermined location inside a light-transmissive material and forming a code in which processing information is recorded.

The processing information is information for forming a processed object that is obtained as a result of a laser beam being impinged onto a processed region in a light-transmissive material. The processing information is information used in forming the processed object, such as the processing data for forming the processed object (see the first preferred embodiment), or information on cautionary points for the processing, characteristics, properties, etc. of the processing material, tools needed to process the material, and so on. The processing information is an example of “predetermined information”.

If a code representing processing information is formed in the processing material in this way, the processing system 100 can form the processed object by reading the code and referring to the processing information recorded in the code.

In this case, the processing apparatus 1 is provided with a reader or scanner or OCR device to read the code. The computer 2 controls the processing apparatus 1 so that the processing apparatus 1 analyzes the code having been read and processes the processing material. The processing apparatus 1 impinges a laser beam onto the processed region indicated by the processing data and forms the processed object.

In this way, as a result of the processing information for forming the processed object being recorded in the code as predetermined information, the processing data, and the like, can be incorporated in the processing material itself. Moreover, the laser beam processing method in this preferred embodiment makes it possible to impinge a laser beam onto a processed region in a light-transmissive material in accordance with the processing information and form a processed object. Accordingly, there is no need to create a new piece of processing data, and the like, at the CAD/CAM system 200.

The processing material in this preferred embodiment is a light-transmissive material used in forming a processed object and has, formed inside the material at a predetermined location, a code in which the processing information for forming the processed object is recorded. A code that is formed inside a processing material in this way is less prone to degrade over time or to falsification.

Note that it is also possible to form a code, in which the predetermined information (processed object information and information on use) described in the first preferred embodiment and the modification thereof is recorded, in a processed object that is obtained as a result of processing a processing material by reading a code formed in the processing material.

It is possible to use a non-transitory computer readable medium on which a processing program for executing any of the laser beam processing methods in the above preferred embodiments is recorded, and provide the program to the computer. Examples of such non-transitory computer readable media include a magnetic recording medium (e.g. flexible disc, magnetic tape, or hard disk drive), compact disk-read only memory (CD-ROM), and so on.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-8. (canceled)

9. A laser beam processing method comprising:
impinging a laser beam onto a predetermined location inside a light-transmissive material; and
forming a code in which predetermined information is recorded.

10. The laser beam processing method according to claim 9, wherein the predetermined information includes processed object information pertaining to a processed object obtained as a result of a laser beam being impinged onto a processed region in the light-transmissive material.

11. The laser beam processing method according to claim 9, wherein the predetermined information includes information on use obtained during use of a processed object obtained as a result of the laser beam being impinged onto a processed region in the light-transmissive material.

12. The laser beam processing method according to claim 9, wherein the predetermined information includes processing information for forming a processed object obtained as a result of the laser beam being impinged onto a processed region in the light-transmissive material.

13. The laser beam processing method according to claim 12, further comprising impinging the laser beam onto the processed region in accordance with the processing information and forming the processed object.

14. The laser beam processing method according to claim 10, wherein the forming the code includes impinging the laser beam while preventing an overlap between the processed region and the predetermined location of the code.

15. A processed object obtained by processing a light-transmissive material, the processed object comprising:
a code in which predetermined information is recorded and being located at a predetermined position inside the light-transmissive material.

16. A light-transmissive material used for forming a processed object, the light-transmissive material comprising:
a code in which processing information to form the processed object is recorded is located at a predetermined position inside the light-transmissive material.
